(19) United States
(12) Patent Application Publication
(10) Pub. No.: US 2018/0184650 A1
(43) Pub. Date: Jul. 5, 2018

(54) Hydrogen Peroxide Sanitizing Cleaner

(71) Applicants: Jeffrey A. Greene, Arlington, TN (US); Douglas Innes, Cordova, TN (US)

(72) Inventors: Jeffrey A. Greene, Arlington, TN (US); Douglas Innes, Cordova, TN (US)

(21) Appl. No.: 15/860,504

(22) Filed: Jan. 2, 2018

Related U.S. Application Data
(60) Provisional application No. 62/441,515, filed on Jan. 2, 2017.

(51) Int. Cl. A01N 25/30; A01N 59/00; A01N 25/22

(52) U.S. Cl. CPC A01N 25/30; A01N 25/22; A01N 59/00

(57) ABSTRACT

An environmentally safe aqueous hydrogen peroxide disinfecting solution having a pH of at least 2.0 is disclosed. The hydrogen peroxide disinfecting solution comprises a plurality of nonionic surfactants that positively affect surface cleaning and sanitizing and further comprises a plurality of hydrogen peroxide stabilizing agents which enhance the sanitizing cleaner's antimicrobial activity and prevent peroxide auto-decomposition.

### FIELD

This technology relates generally to a hydrogen peroxide sanitizing cleaner and a method of making and using the same. The hydrogen peroxide sanitizing cleaner is an environmentally safe aqueous disinfecting solution comprised of nonionic surfactants that positively affect surface cleaning and sanitizing and is further comprised of stabilizing agents to enhance the sanitizing cleaner's antimicrobial activity and prevent peroxide auto-decomposition.

### BACKGROUND

Hydrogen peroxide aqueous solutions are commonly used for surface cleaning and sanitizing. Such aqueous solutions typically have compositions that are not environmentally safe and/or have compositions that are unable to prevent peroxide auto-decomposition thus affecting the antimicrobial activity of the hydrogen peroxide solution.

There is a need for a hydrogen peroxide sanitizing cleaner that is an environmentally safe aqueous disinfecting solution comprised of nonionic surfactants that positively affect surface cleaning and sanitizing and is further comprised of stabilizing agents to enhance the sanitizing cleaner's antimicrobial activity and prevent peroxide auto-decomposition.

### DETAILED DESCRIPTION

A hydrogen peroxide sanitizing cleaner is disclosed. The hydrogen peroxide sanitizing cleaner is an environmentally safe aqueous disinfecting solution with a pH above 2.0. In one embodiment, the aqueous disinfecting solution may have a composition comprising about 0.5-20.0% by weight of hydrogen peroxide (35% food grade). In another example embodiment, the aqueous disinfecting solution may have a composition comprising about 4.2-12.9% by weight of hydrogen peroxide (35% food grade) wherein 1.5-4.5% is active hydrogen peroxide. Additionally, in one embodiment, the composition may comprise one or more environmentally safe nonionic surfactants which increase the surface cleaning and sanitizing efficacy of the disinfecting solution. In one embodiment, such nonionic surfactants may be an amine oxide such as Ammonyx® LO and an alkyl polyglucoside such as Glucopon® 420 UP. Other nonionic surfactants may be used as desired by one of skill in the art. In one embodiment, the aqueous disinfecting solution may have a composition comprising about 0.1-10.0% by weight of nonionic surfactants. In one example embodiment, the aqueous disinfecting solution may have a composition comprising about 0.25-7.5% by weight of the environmentally safe nonionic surfactant lauramine oxide, Ammonyx® LO. In one example embodiment, the aqueous disinfecting solution may have a composition comprising about 0.1-3.0% by weight of the environmentally safe nonionic surfactant alkyl polyglucoside, Glucopon® 420 UP.

In one embodiment, the composition may comprise one or more hydrogen peroxide stabilizing agents to enhance the sanitizing cleaner's antimicrobial activity and to prevent peroxide auto-decomposition. In one example embodiment, the aqueous disinfecting solution may have a composition comprising a useful concentration range is between 0.01-30.0% by weight. In one embodiment, the hydrogen peroxide sanitizing cleaner may comprise a stabilizing agent comprising an acid such as dehydroerythorbic and dehydroascorbic acids or a combination thereof which become hydrogen peroxide stabilizing additives acting as peroxide stable oxygen radical scavengers that also enhance bacterial kill by providing acidic activity to the sanitizing composition. In an example embodiment, the aqueous disinfecting solution may have a composition comprising a useful concentration range of such stabilizing acid between 0.02-1.2%. Example reactions include:

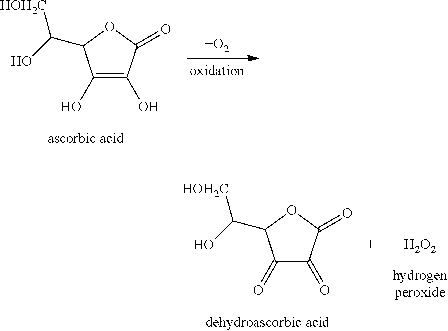

In one embodiment, the dehydroerythorbic may be produced in situ via an initial reaction with hydrogen peroxide.

In another embodiment, the hydrogen peroxide sanitizing cleaner may comprise a stabilizing agent comprising polyols such as xylitol, sorbitol and manitol which may be added to further stabilize the hydrogen peroxide concentration for cleaning and sanitizing by preventing free radical formation when combined with the aforementioned ascorbates. In one example embodiment, the aqueous disinfecting solution may have a composition comprising about 0.25-5.0% by weight of the stabilizing agent comprising polyols. Potential stabilizing reactions include:

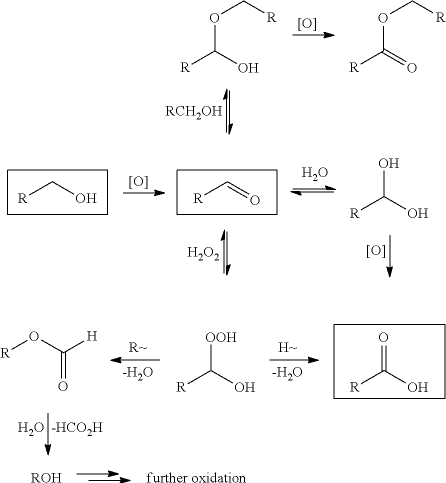

In another example embodiment, the hydrogen peroxide stabilizing agent may comprise a chelators such as Tetrasodium iminodisuccinate (IDS) or N-(1,2-dicarboxyethylene)-D,L-asparagine acid which is used to sequester aqueous metal ions capable of catalyzing the decomposition of hydrogen peroxide and provide additional chelation during surface contact cleaning and sanitizing. Other useful environmentally safe chelators include polyaspartic acid (DS), ethylenediaminedisuccinic acid (EDDS), N,N-bis(carboxymethyl) glutamic acid (GLDA), methylglycinediacetic acid (MGDA) and citric acid. In one example embodiment, the aqueous disinfecting solution may have a composition comprising about 0.1-8.5% by weight of the chelating agent.

Additionally, the hydrogen peroxide stabilizing agent may comprise terpenes such as D or L Limonene or their racemic mixtures which may be added to the composition as a peroxide stable fragrance enhancer. In one embodiment, less than 2% D-Limonene is used in the composition. In one embodiment, the composition may be modified to be food grade.

In one example embodiment, a compositional formulational example of the hydrogen peroxide sanitizing cleaner may be:

### Example Formula 1

| | Percentage Raw Material |
|---|---|
| Raw Material | in Formulation (%) |
| Water | 82.05 |
| Erythorbic Acid (crystalline) | 2.50 |
| Baypure CX100 (34% Tetrasodium | 0.25 |
| Iminodisuccinate) | |
| Xylitol (crystalline) | 1.00 |
| Ammonyx LO (22% Amine Oxide) | 1.50 |
| Glucopon 420 UP | 0.60 |
| (50% Alkyl Polyglucoside C8-C16) | |
| Hydrogen Peroxide (17.5%) | 12.00 |
| D-Limonene | 0.10 |

In another example embodiment, a compositional formulational example of the hydrogen peroxide sanitizing cleaner may be:

### Example Formula 2

| | Percentage Raw Material |
|---|---|
| Raw Material | in Formulation (%) |
| Water | 84.0 |
| Erythorbic Acid (crystalline) | 1.5 |
| Baypure CX100 (34% Tetrasodium | 0.3 |
| Iminodisuccinate) | |
| Xylitol (crystalline) | 2.0 |
| Ammonyx LO (22% Amine Oxide) | 1.5 |
| Glucopon 420 UP | 0.6 |
| (50% Alkyl Polyglucoside C8-C16) | |
| Hydrogen Peroxide (17.5%) | 10.0 |
| D-Limonene | 0.1 |

In a further example embodiment, a compositional formulational example of the hydrogen peroxide sanitizing cleaner may be:

### Example Formula 3

| | Percentage Raw Material |
|---|---|
| Raw Material | in Formulation (%) |
| Water | 85.38 |
| Erythorbic Acid (crystalline) | 0.12 |
| Citric Acid (crystalline) | 1.50 |
| Baypure CX100 (34% Tetrasodium | 1.20 |
| Iminodisuccinate) | |
| Xylitol (crystalline) | 0.50 |
| Ammonyx LO (22% Amine Oxide) | 1.00 |
| Glucopon 420 UP | 0.30 |
| (50% Alkyl Polyglucoside C8-C16) | |
| Hydrogen Peroxide (17.5%) | 10.00 |

In a further example embodiment, a concentrated compositional formulational example of the hydrogen peroxide sanitizing cleaner may be:

### Example Formula 4

| | Percentage Raw Material |
|---|---|
| Raw Materials | in Formulation (%) |
| Water | 30.25 |
| Citric Acid | 7.50 |
| Baypure CX100 (34% tetra sodium | 1.25 |
| iminodisuccinate) | |
| Ammonyx LO (22% Amine Oxide Surfactant) | 7.50 |
| Glucopon 420 UP | 3.00 |
| (50% Alkyl Polyglucoside, C8-C14) | |
| Hydrogen Peroxide (17.5%) | 50.00 |
| D-limonene | 0.50 |

In a still further example embodiment, a concentrated compositional formulational example of the hydrogen peroxide sanitizing cleaner may be:

### Example Formula 5

| | Percentage Raw Material |
|---|---|
| Raw Materials | in Formulation (%) |
| Water | 30.25 |
| Citric Acid | 7.50 |
| Baypure CX100 (34% tetra sodium | 1.25 |
| iminodisuccinate) | |
| Ammonyx LO (22% Amine Oxide Surfactant) | 7.50 |
| Glucopon 420 UP (50% Alkyl Polyglucoside, | 3.00 |
| C8-C14) | |
| Hydrogen Peroxide (35%) | 50.00 |
| D-limonene | 0.50 |

In a still further example embodiment, a concentrated compositional formulational example of the hydrogen peroxide sanitizing cleaner may be:

### Example Formula 6

| | Percentage Raw Material |
|---|---|
| Raw Materials | in Formulation (%) |
| Water | 88.89 |
| Citric Acid | 0.85 |
| Erythorbic Acid | 0.12 |
| Xylitol | 0.50 |
| Lauramine Oxide | 0.75 |
| Glucopon 420 UP (50% Alkyl Polyglucoside, | 0.30 |
| C8-C14) | |
| Hydrogen Peroxide (35%) | 8.59 |
| | (3% active) |

In a still further example embodiment, a concentrated compositional formulational example of the hydrogen peroxide sanitizing cleaner may be:

### Example Formula 7

| | Percentage Raw Material |
|---|---|
| Raw Materials | in Formulation (%) |
| Water | 90.33 |
| Citric Acid | 0.85 |
| Erythorbic Acid | 0.12 |
| Xylitol | 0.50 |
| Lauramine Oxide | 0.75 |
| Glucopon 420 UP (50% Alkyl Polyglucoside, | 0.30 |
| C8-C14) | |
| Hydrogen Peroxide (35%) | 7.15 |
| | (2.5% active) |

The hydrogen peroxide sanitizing cleaner is highly effective in reducing microbial population of various common bacteria as shown in Tables 1-10 below. discloses the results of such testing. Referring to Tables 1-3 below, example hydrogen peroxide disinfecting solution with example formula 7 (above) was successfully tested in a hydrogen peroxide ladder against the following bacteria S. aureus, P. aeruginosa, and S. enteric. The following Tables 1-3 disclose the results and testing parameters of such testing.

TABLE 1
S. Aureus

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Staphylococcus | 3.2E+05 | 0% H2O2 | A | 4760.0 | 98.40% |
| aureus | | | B | 5480.0 | |
| | | 0.25% H2O2 | A | 2600.0 | 99.18% |
| | | | B | 2680.0 | |
| | | 0.75% H2O2 | A | 1615.0 | 99.5% |
| | | | B | 1485.0 | |
| | | 1.25% H2O2 | A | 625.0 | 99.8% |
| | | | B | 655.0 | |
| | | 1.75% H2O2 | A | 290.0 | 99.91% |
| | | | B | 255.0 | |
| | | 2.00% H2O2 | A | 34.1 | 99.99% |
| | | | B | 30.9 | |
| | | 2.50% H2O2 | A | 11.4 | 99.997% |
| | | | B | 8.2 | |

Referring to Table 1 above, eighteen sterile glass carriers were set in an active laminar flow hood. Following the thirty second homogenization, and fifteen minute rest, the bacterial suspension of S. aureus was streaked for purity, and aliquoted, which was diluted 10-6. Sixteen of the glass carriers were then inoculated with 10 uL of the bacterial suspension each, and allowed to dry for 16:15 minutes. Following observation of total dryness, each test slide set was sprayed three times at a distance of 10 inches with the respective formulae and allowed a contact time of 5:00 minutes. After the contact time, the test slides were immediately deposited into individual 50 mL tubes containing 10 mL of neutralizing broth. The positive and negative control slides received no treatment and were placed directly into individual 50 mL tubes containing 10 mL of neutralizing broth following drying. After transferring the slides, the tubes were placed on an orbital shaker for 10 minutes to elute the bacteria. The neutralization control (exposed to the 2.50% H2O2 formula and subsequently neutralized) was inoculated with 10 uL drawn from an eluted positive control tube. The samples were plated directly onto TSA in duplicates of 0.1 mL and 1.0 mL. The positive control samples were diluted 1/1000 in PBW prior to plating.

TABLE 2
S. enterica Serovar Typhimurium

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H202 % | Replicate | (cfu/mL) | Reduction |
| Salmonella enterica | 1.2E+05 | 0% H2O2 | A | <0.45 | >99.9996% |
| Serovar | | | B | <0.45 | |
| Typhimurium | | 0.25% H2O2 | A | <0.45 | >99.9996% |
| | | | B | <0.45 | |
| | | 0.75% H2O2 | A | <0.45 | >99.9996% |
| | | | B | <0.45 | |
| | | 1.25% H2O2 | A | <0.45 | >99.9996% |
| | | | B | <0.45 | |
| | | 1.75% H2O2 | A | <0.45 | >99.9996% |
| | | | B | <0.45 | |
| | | 2.00% H2O2 | A | <0.45 | >99.9996% |
| | | | B | <0.45 | |
| | | 2.50% H2O2 | A | <0.45 | >99.9996% |
| | | | B | <0.45 | |

TABLE 3
P. aeruginosa

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Pseudomonas | 6.4E+04 | 0% H2O2 | A | 5.5 | 99.993% |
| aeruginosa | | | B | 3.1 | |
| | | 0.25% H2O2 | A | <0.45 | >99.9993% |
| | | | B | <0.45 | |
| | | 0.75% H2O2 | A | <0.45 | >99.9993% |
| | | | B | <0.45 | |
| | | 1.25% H2O2 | A | <0.45 | >99.9993% |
| | | | B | <0.45 | |
| | | 1.75% H2O2 | A | <0.45 | >99.9993% |
| | | | B | <0.45 | |
| | | 2.00% H2O2 | A | <0.45 | >99.9993% |
| | | | B | <0.45 | |
| | | 2.50% H2O2 | A | <0.45 | >99.9993% |
| | | | B | <0.45 | |

Referring to Table 3 above, eighteen sterile glass carriers were set in an active laminar flow hood. Following the 30 second homogenization, and 15 minute rest, the bacterial suspension of P. aeruginosa and Salmonella enterica Serovar Typhimur were streaked for purity, and aliquoted, which was diluted 10-6. Two sets of 16 glass carriers were then inoculated with 10 uL of the individual bacterial suspension each, and allowed to dry for 25:18 minutes. Following observation of total dryness, each test slide set was sprayed three times at a distance of 10 inches with the respective formula, and allowed a contact time of five minutes. After the contact time, the test slides were immediately deposited into individual 50 mL tubes containing 10 mL of neutralizing broth. The positive and negative control slides received no treatment and were placed directly into individual 50 mL tubes containing 10 mL of neutralizing broth following drying. After transferring the slides, the tubes were placed on an orbital shaker for ten minutes to elute the bacteria. The neutralization control (exposed to the 2.50% H2O2 formula and subsequently neutralized) was inoculated with 10 uL drawn from an eluted positive control tube for each bacteria. The samples were plated directly onto TSA in duplicates of 0.1 mL, and 1.0 mL. The positive control samples were diluted 1/1000 in PBW prior to plating.

The hydrogen peroxide disinfecting solution is additionally highly effective in reducing the microbial population of various bacteria including E. faecalis, E. coli, K. pneumoniae, S. dysenteriae, L. monocytogenes, S. pyogenes, and E. aerogenes. The example compositional formula 6 set forth above was successfully tested in a hydrogen peroxide ladder for the technology against such bacteria. The test parameters and results are set forth in Tables 4-9

TABLE 4
L. monocytogenes

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Listeria | 7.5E+04 | 0% H2O2 | A | <0.45 | >99.9994% |
| monocytogenes | | | B | <0.45 | |
| | | 0.75% H2O2 | A | <0.45 | >99.9994% |
| | | | B | <0.45 | |
| | | 1.25% H2O2 | A | <0.45 | >99.9994% |
| | | | B | <0.45 | |
| | | 1.75% H2O2 | A | <0.45 | >99.9994% |
| | | | B | <0.45 | |
| | | 2.00% H2O2 | A | <0.45 | >99.9994% |
| | | | B | <0.45 | |
| | | 2.50% H2O2 | A | <0.45 | >99.9994% |
| | | | B | <0.45 | |
| | | 3.00% H2O2 | A | <0.45 | >99.9994% |
| | | | B | <0.45 | |

Referring to Table 4 above, L. monocytogenes culture was grown in Tryptic Soy Broth for 18-20 hours at 36.5 degrees C. The culture was homogenized and verified for purity and concentration. Following rest, the bacterial suspension was inoculated onto the test carriers. Briefly, 18 sterile glass (20×25 mm) carriers were placed onto a sterile platform in a biological cabinet. Sixteen of the glass carriers were each inoculated with 10 uL of the bacterial suspension, and allowed to rest until visibly dry (15-20 minutes). Following, duplicate inoculated carriers were sprayed until saturated (five trigger pulls) from a distance of approximately 12 inches with the respective formula. The carriers were allowed a contact time of five minutes. Following, the duplicate treatment carriers, negative controls (duplicate uninoculated glass carriers treated with the 0%/o H2O2 formula), positive controls (duplicate inoculated carriers that were dried and received no spray treatment), and neutralization control (uninoculated carrier treated with the 3.00% H2O2 formula) were each immediately and aseptically transferred into individual 50 mL tubes containing 10 mL of neutralizing broth. The tubes were placed on an orbital shaker for 10 minutes. Neutralization control was inoculated with 10 uL drawn from an eluted positive control tube. The samples were plated directly onto TSA in duplicates of 0.1 mL and 1.0 mL. The positive control samples were diluted 1/1000 in PBW prior to plating. Inoculated plates were incubated at 36.5 degrees C. for 48 hours prior to colony enumeration.

TABLE 5
K. pneumoniae

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Klebsiella | 4.2E+05 | 0% H2O2 | A | <0.45 | >99.9999% |
| pneumoniae | | | B | <0.45 | |
| | | 0.75% H2O2 | A | <0.45 | >99.9999% |
| | | | B | <0.45 | |
| | | 1.25% H2O2 | A | <0.45 | >99.9999% |
| | | | B | <0.45 | |
| | | 1.75% H2O2 | A | <0.45 | >99.9999% |
| | | | B | <0.45 | |
| | | 2.00% H2O2 | A | <0.45 | >99.9999% |
| | | | B | <0.45 | |
| | | 2.50% H2O2 | A | <0.45 | >99.9999% |
| | | | B | <0.45 | |
| | | 3.00% H2O2 | A | <0.45 | >99.9999% |
| | | | B | <0.45 | |

Referring to Table 5, K. pneumoniae culture was grown in Tryptic Soy Broth for 18-20 hours at 36.5 degrees C. The culture was homogenized and verified for purity and concentration. Following rest, the bacterial suspension was inoculated onto the test carriers. Briefly, eighteen sterile glass (20×25 mm) carriers were placed onto a sterile platform in a biological cabinet. Sixteen of the glass carriers were each inoculated with 10 uL of the bacterial suspension, and allowed to rest until visibly dry (15-20 minutes). Following, duplicate inoculated carriers were sprayed until saturated (five trigger pulls) from a distance of approximately 12 inches with the respective formula. The carriers were allowed a contact time of five minutes. Following, the duplicate treatment carriers, negative controls (duplicate uninoculated glass carriers treated with the 0% H2O2 formula), positive controls (duplicate inoculated carriers that were dried and received no spray treatment), and neutralization control (uninoculated carrier treated with the 3.00% H2O2 formula) were each immediately and aseptically transferred into individual 50 mL tubes containing 10 mL of neutralizing broth. The tubes were placed on an orbital shaker for ten minutes. Neutralization control was inoculated with 10 uL drawn from an eluted positive control tube. The samples were plated directly onto TSA in duplicates of 0.1 mL and 1.0 mL. The positive control samples were diluted 1/1000 in PBW prior to plating. Inoculated plates were incubated at 36.5 degrees C. for 24 hours prior to colony enumeration.

TABLE 6
S. pGyogenes

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Streptococcus | 8.8E+04 | 0% H2O2 | A | <0.45 | >99.9995% |
| pyogenes | | | B | <0.45 | |
| | | 0.75% H2O2 | A | <0.45 | >99.9995% |
| | | | B | <0.45 | |
| | | 1.25% H2O2 | A | <0.45 | >99.9995% |
| | | | B | <0.45 | |
| | | 1.75% H2O2 | A | <0.45 | >99.9995% |
| | | | B | <0.45 | |
| | | 2.00% H2O2 | A | <0.45 | >99.9995% |
| | | | B | <0.45 | |
| | | 2.50% H2O2 | A | <0.45 | >99.9995% |
| | | | B | <0.45 | |
| | | 3.00% H2O2 | A | <0.45 | >99.9995% |
| | | | B | <0.45 | |

Referring to Table 6 above, S. pyogenes culture was grown in Bovine Heart Infusion Broth for 18-20 hours at 36.5 degrees C. The culture was homogenized and verified for purity and concentration. Following rest, the bacterial suspension was inoculated onto the test carriers. Eighteen sterile glass (20×25 mm) carriers were placed onto a sterile platform in a biological cabinet. Sixteen of the glass carriers were each inoculated with 10 uL of the bacterial suspension and allowed to rest until visibly dry (15-20 minutes). Following, duplicate inoculated carriers were sprayed until saturated (five trigger pulls) from a distance of approximately 12 inches with the respective formula. The carriers were allowed a contact time of five minutes. Following the duplicate treatment carriers, negative controls (duplicate uninoculated glass carriers treated with the 0% H2O2 formula), positive controls (duplicate inoculated carriers that were dried and received no spray treatment), and neutralization control (uninoculated carrier treated with the 3.00% H2O2 formula) were each immediately and aseptically transferred into individual 50 mL tubes containing 10 mL of neutralizing broth. The tubes were placed on an orbital shaker for ten minutes. Neutralization control was inoculated with 10 uL drawn from an eluted positive control tube. The samples were plated directly onto 5% Sheep's Blood Tryptic Soy Agar in duplicates of 0.1 mL, and 1.0 mL. The positive control samples were diluted 1/1000 in PBW prior to plating. Inoculated plates were incubated at 36.5 degrees C. for 48 hours prior to colony enumeration.

TABLE 7
S. dysenteriae

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Shigella | 5.0E+04 | 0% H2O2 | A | <0.45 | >99.9991% |
| dysenteriae | | | B | <0.45 | |
| | | 0.75% H2O2 | A | <0.45 | >99.9991% |
| | | | B | <0.45 | |
| | | 1.25% H2O2 | A | <0.45 | >99.9991% |
| | | | B | <0.45 | |
| | | 1.75% H2O2 | A | <0.45 | >99.9991% |
| | | | B | <0.45 | |
| | | 2.00% H2O2 | A | <0.45 | >99.9991% |
| | | | B | <0.45 | |
| | | 2.50% H2O2 | A | <0.45 | >99.9991% |
| | | | B | <0.45 | |
| | | 3.00% H2O2 | A | <0.45 | >99.9991% |
| | | | B | <0.45 | |

Referring to Table 7 above, S. dysenteria culture was grown in Tryptic Soy Broth for 18-20 hours at 36.5 degrees C. The culture was homogenized and verified for purity and concentration. Following rest, the bacterial suspension was inoculated onto the test carriers. Eighteen sterile glass (20×25 mm) carriers were placed onto a sterile platform in a biological cabinet. Sixteen of the glass carriers were each inoculated with 10 uL of the bacterial suspension and allowed to rest until visibly dry (15-20 minutes). Following, duplicate inoculated carriers were sprayed until saturated (five trigger pulls) from a distance of approximately twelve inches with the respective formula. The carriers were allowed a contact time of five minutes. Following, the duplicate treatment carriers, negative controls (duplicate uninoculated glass carriers treated with the 0% H2O2 formula), positive controls (duplicate inoculated carriers that were dried and received no spray treatment), and neutralization control (uninoculated carrier treated with the 3.00% H2O2 formula) were each immediately and aseptically transferred into individual 50 mL tubes containing 10 mL of neutralizing broth. The tubes were placed on an orbital shaker for 10 minutes. Neutralization control was inoculated with 10 uL drawn from an eluted positive control tube. The samples were plated directly onto TSA in duplicates of 0.1 mL, and 1.0 mL. The positive control samples were diluted 1/1000 in PBW prior to plating. Inoculated plates were incubated at 36.5 degrees C. for 24 hours prior to colony enumeration.

TABLE 8
E. Coli

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Escherichia coli | 6.2E+04 | 0% H2O2 | A | <0.45 | >99.9993% |
| O157:H7 | | | B | <0.45 | |
| | | 0.75% H2O2 | A | <0.45 | >99.9993% |
| | | | B | <0.45 | |
| | | 1.25% H2O2 | A | <0.45 | >99.9993% |
| | | | B | <0.45 | |
| | | 1.75% H2O2 | A | <0.45 | >99.9993% |
| | | | B | <0.45 | |
| | | 2.00% H2O2 | A | <0.45 | >99.9993% |
| | | | B | <0.45 | |
| | | 2.50% H2O2 | A | <0.45 | >99.9993% |
| | | | B | <0.45 | |
| | | 3.00% H2O2 | A | <0.45 | >99.9993% |
| | | | B | <0.45 | |

Referring to Table 8 above, E. coli O157:H7 culture was grown in Tryptic Soy Broth for 18-20 hours at 36.5 degrees C. The culture was homogenized and verified for purity and concentration. Following rest, the bacterial suspension was inoculated onto the test carriers. Briefly, eighteen sterile glass (20×25 mm) carriers were placed onto a sterile platform in a biological cabinet. Sixteen of the glass carriers were each inoculated with 10 uL of the bacterial suspension and allowed to rest until visibly dry (15-20 minutes). Following, duplicate inoculated carriers were sprayed until saturated (five trigger pulls) from a distance of approximately 12 inches with the respective formula. The carriers were allowed a contact time of five minutes. Following, the duplicate treatment carriers, negative controls (duplicate uninoculated glass carriers treated with the 0% H2O2 formula), positive controls (duplicate inoculated carriers that were dried and received no spray treatment), and neutralization control (uninoculated carrier treated with the 3.00% H2O2 formula) were each immediately and aseptically transferred into individual 50 mL tubes containing 10 mL of neutralizing broth. The tubes were placed on an orbital shaker for 10 minutes. Neutralization control was inoculated with 10 uL drawn from an eluted positive control tube. The samples were plated directly onto TSA in duplicates of 0.1 mL, and 1.0 mL. The positive control samples were diluted 1/1000 in PBW prior to plating. Inoculated plates were incubated at 36.5 degrees C. for 24 hours prior to colony enumeration.

TABLE 9
E. faecalis

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Enterococcus | 3.2E+05 | 0% H2O2 | A | 168.6 | 99.95% |
| faecalis | | | B | 135.0 | |
| | | 0.75% H2O2 | A | 60.9 | 99.98% |
| | | | B | 58.6 | |
| | | 1.25% H2O2 | A | 24.1 | 99.993% |
| | | | B | 20.0 | |
| | | 1.75% H2O2 | A | <0.45 | 99.9999% |
| | | | B | <0.45 | |
| | | 2.00% H2O2 | A | <0.45 | 99.9999% |
| | | | B | <0.45 | |
| | | 2.50% H2O2 | A | <0.45 | 99.9999% |
| | | | B | <0.45 | |
| | | 3.00% H2O2 | A | <0.45 | 99.9999% |
| | | | B | <0.45 | |

Referring to Table 9 above, E. faecalis culture was grown in Tryptic Soy Broth for 18-20 hours at 36.5 degrees C. The culture was homogenized and verified for purity and concentration. Following rest, the bacterial suspension was inoculated onto the test carriers. Briefly, eighteen sterile glass (20×25 mm) carriers were placed onto a sterile platform in a biological cabinet. Sixteen of the glass carriers were each inoculated with 10 uL of the bacterial suspension and allowed to rest until visibly dry (15-20 minutes). Following, duplicate inoculated carriers were sprayed until saturated (five trigger pulls) from a distance of approximately 12 inches with the respective formula. The carriers were allowed a contact time of five minutes. Following, the duplicate treatment carriers, negative controls (duplicate uninoculated glass carriers treated with the 0% H2O2 formula), positive controls (duplicate inoculated carriers that were dried and received no spray treatment), and neutralization control (uninoculated carrier treated with the 3.00% H2O2 formula) were each immediately and aseptically transferred into individual 50 mL tubes containing 10 mL of neutralizing broth. The tubes were placed on an orbital shaker for ten minutes. Neutralization control was inoculated with 10 uL drawn from an eluted positive control tube. The samples were plated directly onto TSA in duplicates of 0.1 mL and 1.0 mL. The positive control samples were diluted 1/1000 in PBW prior to plating. Inoculated plates were incubated at 36.5 degrees C. for 24 hours prior to colony enumeration.

TABLE 10
E. aerogenes

| | | | | Microorganisms | |
|---|---|---|---|---|---|
| | Microorganisms | | | Remaining | |
| | Prior to | Composition | | Following | Average |
| | Treatment | with varying | | Treatment | Percent |
| Microorganism | (cfu/mL) | H2O2 % | Replicate | (cfu/mL) | Reduction |
| Enterobacter | 2.4E+05 | 0% H2O2 | A | <0.45 | 99.9998% |
| aerogenes | | | B | <0.45 | |
| | | 0.75% H2O2 | A | <0.45 | 99.9998% |
| | | | B | <0.45 | |
| | | 1.25% H2O2 | A | <0.45 | 99.9998% |
| | | | B | <0.45 | |
| | | 1.75% H2O2 | A | <0.45 | 99.9998% |
| | | | B | <0.45 | |
| | | 2.00% H2O2 | A | <0.45 | 99.9998% |
| | | | B | <0.45 | |
| | | 2.50% H2O2 | A | <0.45 | 99.9998% |
| | | | B | <0.45 | |
| | | 3.00% H2O2 | A | <0.45 | 99.9998% |
| | | | B | <0.45 | |

Referring to Table 10 above, E. aerogenes culture was grown in Tryptic Soy Broth for 18-20 hours at 36.5 degrees C. The culture was homogenized and verified for purity and concentration. Following rest, the bacterial suspension was inoculated onto the test carriers. Briefly, eighteen sterile glass (20×25 mm) carriers were placed onto a sterile platform in a biological cabinet. Sixteen of the glass carriers were each inoculated with 10 uL of the bacterial suspension, and allowed to rest until visibly dry (15-20 minutes). Following, duplicate inoculated carriers were sprayed until saturated (five trigger pulls) from a distance of approximately twelve inches with the respective formula. The carriers were allowed a contact time of five minutes. Following, the duplicate treatment carriers, negative controls (duplicate uninoculated glass carriers treated with the 0% H2O2 formula), positive controls (duplicate inoculated carriers that were dried and received no spray treatment), and neutralization control (uninoculated carrier treated with the 3.00% H2O2 formula) were each immediately and aseptically transferred into individual 50 mL tubes containing 10 mL of neutralizing broth. The tubes were placed on an orbital shaker for ten minutes. Neutralization control was inoculated with 10 uL drawn from an eluted positive control tube. The samples were plated directly onto TSA in duplicates of 0.1 mL, and 1.0 mL. The positive control samples were diluted 1/1000 in PBW prior to plating. Inoculated plates were incubated at 36.5 degrees C. for 24 hours prior to colony enumeration. The following Charts 1-3 depict the relationship between that the stabilizing agents and the loss of hydrogen peroxide over time. The information set forth is Charts 1-3 demonstrate that the hydrogen peroxide disinfecting solution allows minimal hydrogen peroxide loss over time. The following three formulas were tested:

Formulas Tested

| | | % | % | % | % | % | | | % | |
|---|---|---|---|---|---|---|---|---|---|---|
| | % | Citric | Baypure | Lauramine | Gloucopon | H2O2 | % D- | % | Erythorbic | Formula |
| Formula | Water | Acid | CX100 | Oxide | 420 UP | (35%) | Limonene | Xylitol | Acid | Total |
| Unstabilized | 30.5 | 7.25 | 1.25 | 7.5 | 3.0 | 50.0 | 0.5 | 0 | 0 | 100 |
| Chart 1 | | | | | | | | | | |
| Stabilized | 24.8 | 8.5 | 0 | 7.5 | 3.0 | 50.0 | 0 | 5.0 | 1.2 | 100 |
| Chart 2 | | | | | | | | | | |
| RTU | 92.48 | 0.85 | 0 | 0.75 | 0.30 | 5.00 | 0 | 0.50 | 0.12 | 100 |
| Stabilized | | | | | | | | | | |
| Chart 3 | | | | | | | | | | |

Chart 1 depicts the hydrogen peroxide disinfecting solution without stabilizing agent or unstabilized hydrogen peroxide formula. The chart depicts the percentage of hydrogen peroxide loss over twenty seven week period.

| Weeks | % H₂O₂ |
|---|---|
| 0 | 17.19 |
| 1 | 17.15 |
| 2 | 16.81 |
| 4 | 16.42 |
| 5 | 16.27 |
| 6 | 15.94 |
| 10 | 14.34 |
| 14 | 12.86 |
| 16 | 12.34 |
| 20 | 10.79 |
| 22 | 10.17 |
| 27 | 8.82 |

Chart 2 depicts the hydrogen peroxide disinfecting solution with stabilizing agent or stabilizing hydrogen peroxide formula. The chart depicts the percentage of hydrogen peroxide loss over seventeen week period.

| Weeks | % H₂O₂ |
|---|---|
| 0 | 17.15 |
| 1 | 16.68 |
| 2 | 16.3 |
| 4 | 15.45 |
| 5 | 15.62 |
| 6 | 15.41 |
| 10 | 13.49 |
| 12 | 12.91 |
| 17 | 11.32 |

Chart 3 depicts the ready to use (RTU) hydrogen peroxide disinfecting solution with stabilizing agent or stabilizing hydrogen peroxide formula. The chart depicts the percentage of hydrogen peroxide loss over twelve week period.

| Weeks | % H₂O₂ |
|---|---|
| 0 | 1.67 |
| 1 | 1.64 |
| 2 | 1.52 |
| 4 | 1.63 |
| 5 | 1.63 |
| 7 | 1.61 |
| 12 | 1.6 |

The description and example compositions are by way of example only. While the description above makes reference to various embodiments, it should be understood that many changes and modifications can be made without departing from the scope of the disclosure. Many more example embodiments and implementations are possible within the scope of this invention and will be apparent to those of ordinary skill in the art. The technology is not limited to the specific details, representative embodiments, and example compositions in this description.

We claim:

1. An environmentally safe aqueous hydrogen peroxide disinfecting solution having a pH of at least 2.0, wherein the solution comprises a plurality of nonionic surfactants that positively affect surface cleaning and sanitizing and a plurality of hydrogen peroxide stabilizing agents which enhance the sanitizing cleaner's antimicrobial activity and prevent peroxide auto-decomposition.

2. An aqueous disinfecting solution comprising:
a. hydrogen peroxide at about 0.5-20.0% weight percent in formula;
b. at least one nonionic surfactant at about 0.1-10.0% weight percent in formula, wherein the surfactant is selected from a group consisting of amine oxide, alkyl polyglucoside or a combination thereof;
c. at least one hydrogen peroxide stabilizing agent at about 0.01-30.0% weight percent in formula, wherein the hydrogen peroxide stabilizing agent is selected from the group consisting of xylitol, sorbitol, manitol, dehydroerythorbic acid, dehydroascorbic acid, tetrasodium iminodisuccinate, N-(1,2-dicarboxyethylene)-D,L-asparagine acid, polyaspartic acid, ethylenediaminedisuccinic acid, N,N-bis(carboxymethyl) glutamic acid, methylglycinediacetic acid, citric acid or a combination thereof; and
d. water at about 30.0-96.0% weight percent in formula.

3. The aqueous disinfecting solution of claim 2, wherein solution comprises about 4.2-12.9% by weight of hydrogen peroxide (35% food grade) wherein 1.5-4.5% is active hydrogen peroxide.

4. The aqueous disinfecting solution of claim 2, wherein the aqueous disinfecting solution comprises about 0.25-7.5% by weight of the environmentally safe nonionic surfactant lauramine oxide and about 0.1-3.0% by weight of the environmentally safe nonionic surfactant alkyl polyglucoside.

5. The aqueous disinfecting solution of claim 2, wherein the aqueous disinfecting solution comprises a plurality of hydrogen peroxide stabilizing agent including (a) at least one polyol at about 0.25-5.0% weight percent in formula, wherein the polyol is selected from the group consisting of xylitol, sorbitol, manitol or combination thereof; (b) at least one acid at about 0.02-1.2% weight percent in formula, wherein the acid is selected from a group consisting of dehydroerythorbic acid, dehydroascorbic acid or a combination thereof; and (c) at least one chelating agent at about 0.1-8.5% weight percent in formula, wherein the chelating agent is selected from the group consisting of tetrasodium iminodisuccinate, N-(1,2-dicarboxyethylene)-D,L-asparagine acid, polyaspartic acid, ethylenediaminedisuccinic acid, N,N-bis(carboxymethyl) glutamic acid, methylglycinediacetic acid, citric acid and or a combination thereof.

6. The aqueous disinfecting solution of claim 2, wherein the aqueous disinfecting solution comprises a hydrogen peroxide stable fragrance enhancer selected from the group consisting of D or L limonene or their racemic mixtures.

7. The aqueous disinfecting solution of claim 2, wherein the aqueous disinfecting solution comprises about 61.9-95.08% by weight of water.

8. The aqueous disinfecting solution comprising:
a. hydrogen peroxide at about 4.2-12.9% weight percent in formula;
b. alkyl polyglucoside at about 0.1-3.0% weight percent in formula;
c. lauramine oxide at about 0.25-5.0% weight percent in formula;
d. xylitol at about 0.25-7.5% weight percent in formula;
e. erythorbic acid at about 0.02-1.2% weight percent in formula;
f. citric acid at about 0.1-8.5% by weight percent in formula; and
g. water at about 61.9-95.08% by weight percent in formula.
